(19) United States
(12) Patent Application Publication
(10) Pub. No.: US 2011/0218994 A1
(43) Pub. Date: Sep. 8, 2011

(54) KEYWORD AUTOMATION OF VIDEO CONTENT

(75) Inventors: Christopher E. Holladay, Marietta, GA (US); William P. Shaouy, Atlanta, GA (US)

(73) Assignee: INTERNATIONAL BUSINESS MACHINES CORPORATION, Armonk, NY (US)

(21) Appl. No.: 12/717,988

(22) Filed: Mar. 5, 2010

(51) Int. Cl. G06F 17/30

(52) U.S. Cl. 707/737; 707/750; 707/741; 707/E17.089; 707/E17.054; 707/E17.002; 707/752

(57) ABSTRACT

A system and associated method for automatically processing keyword for video content. The video content contains image frames and an audio stream. An image pattern table for image patterns from the image frames and a word pattern table for word patterns from the audio stream are generated by use of respective pattern names provided by pattern recognition tools. Each pattern is associated with a respective count indicating a number of appearances of each pattern. A respective weight of each pattern is calculated as a relative frequency of each pattern. The image pattern table and the word pattern table are merged to generate a keyword list. A predefined number of most frequently appeared patterns are selected by examining the respective weight of each pattern and metadata associated with the video content are updated to utilize pattern names of the selected patterns as keyword for web searches.

### BACKGROUND OF THE INVENTION

The present invention discloses a system and associated method for automatically generating and associating search keywords for video content. In conventional methods, the search keywords for the video content are manually created and assigned to the video content, which makes the registration of the video content in a web site inefficient. Also, because the manually created search keywords are arbitrarily associated with the video content, the search keywords in conventional methods are not conducive to search of the video content for users.

### BRIEF SUMMARY

According to one embodiment of the present invention, a method for automatically processing keyword for video content comprises, by a processor of a computer system, loading said video content, said video content comprising at least one image frame and an audio stream; generating an image pattern table from said at least one image frame, wherein an entry of the image pattern table comprises attributes of image pattern identifier, image pattern name, image pattern count, and image pattern weight, wherein the image pattern identifier identifies an image pattern in said at least one image frame, wherein the image pattern name is an alphanumeric text representing the image pattern, wherein the image pattern count represents a number of appearances of the image pattern in said at least one image frame, and wherein the image pattern weight represents a relative frequency of the image pattern within said at least one image frame; generating a word pattern table from the audio stream, wherein an entry of the word pattern table comprises attributes of word pattern identifier, word pattern name, word pattern count, and word pattern weight, wherein the word pattern identifier identifies a word pattern in the audio stream, wherein the word pattern name is an alphanumeric text representing the word pattern, wherein the word pattern count represents a number of appearances of the word pattern in the audio stream, and wherein the word pattern weight represents a relative frequency of the word pattern within the audio stream; calculating the respective weight for all entries in the image pattern table and the word pattern table, wherein the respective weight is selected from the group consisting of the image pattern weight and the word pattern weight; generating a keyword list from the image pattern table and the word pattern table based on the calculated weight, wherein an entry of the keyword list is selected from the group consisting of entries of the image pattern table and entries of the word pattern table, and wherein the entry of the keyword list comprises attributes of generic pattern identifier, generic pattern name, generic pattern count, and generic pattern weight; and integrating the generated keyword list into metadata of a web page associated with the video content such that the keyword list is utilized in web searches employing the metadata.

According to one embodiment of the present invention, a computer program product comprises a computer readable memory unit that embodies a computer readable program code. The computer readable program code contains instructions that, when run by a processor of a computer system, implement a method for automatically processing keyword for video content.

According to one embodiment of the present invention, a computer system comprises a processor and a computer readable memory unit coupled to the processor, wherein the computer readable memory unit containing instructions that, when run by the processor, implement a method for automatically processing keyword for video content.

According to one embodiment of the present invention, a process for supporting computer infrastructure, said process comprising providing at least one support service for at least one of creating, integrating, hosting, maintaining, and deploying computer-readable code in a computing system, wherein the code in combination with the computing system is capable of performing a method for automatically processing keyword for video content.

### BRIEF DESCRIPTION OF THE SEVERAL VIEWS OF THE DRAWINGS

FIG. 1 illustrates a system 10 for automatically generating and associating search keywords for video content, in accordance with embodiments of the present invention.

FIG. 2 and FIG. 2A are flowcharts depicting a method for automatically generating and associating search keywords for video content, in accordance with the embodiments of the present invention.

FIG. 3 is a flowchart depicting a method for generating the image pattern table for the video content of FIG. 2, being performed by the image pattern table generator, in accordance with the embodiments of the present invention.

FIG. 4 is a flowchart depicting a method for generating the word pattern table for the video content of FIG. 2, being performed by the word pattern table generator, in accordance with the embodiments of the present invention.

FIG. 5 and FIG. 5A are flowcharts depicting a method for calculating a respective weight of pattern names of the image pattern table and the word pattern table, being performed by the pattern weight calculator, in accordance with the embodiments of the present invention.

FIG. 6 is a flowchart depicting a method for generating the keyword list for the video content of FIG. 2, being performed by the keyword list generator, in accordance with the embodiments of the present invention.

FIG. 7 illustrates a computer system used for automating keywords for video content, in accordance with the embodiments of the present invention.

### DETAILED DESCRIPTION

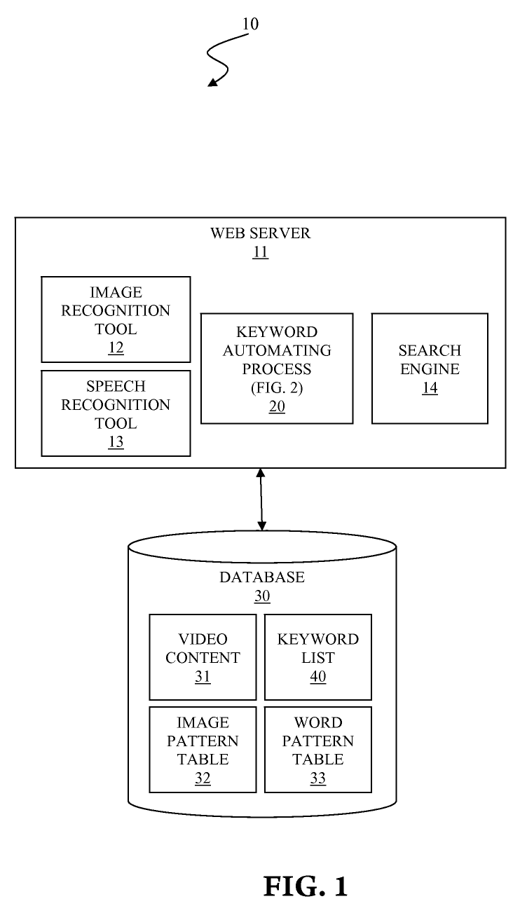

FIG. 1 illustrates a system 10 for automatically generating and associating search keywords for video content, in accordance with embodiments of the present invention.

The system 10 comprises a web server 11 and a database 30. The web server 11 is a computer system that runs an image recognition tool 12, a speech recognition tool 13, a search engine 14, and a keyword automating process 20. The database 30 comprises at least one video content and a keyword list 40 respectively associated with a video content 31 of said at least one video content. The video content 31 comprises at least one image frame and an audio stream. The database 30 also stores an image pattern table 32 and a word pattern table 33 associated with the video content 31 that have been generated by the web server 11. The image pattern table 32 comprises four (4) attributes of image pattern identifier, image pattern name, image pattern count, and image pattern weight. The image pattern table 32 tracks frequency of each image pattern of the video content 31. The word pattern table 33 also comprises four (4) attributes of word pattern identifier, word pattern name, word pattern count, and word pattern weight. The word pattern table 33 tracks frequency of each word pattern of the video content 31.

The keyword automating process 20 takes the video content 31 as an input and creates the keyword list 40 associated with the video content 31 by use of the image pattern table 32 and the word pattern table 33. The keyword automating process 20 invokes the image recognition tool 12 and creates the image pattern table 32 for the video content 31. The keyword automating process 20 invokes the speech recognition tool 13 and creates the word pattern table 33 for the video content 31. The keyword list 40 comprises four (4) attributes of generic pattern identifier, generic pattern name, generic pattern count, and generic pattern weight, as the keyword list 40 is created by merging the image pattern table 32 and the word pattern table 33. The generic pattern identifier takes a value of either the image pattern identifier or the word pattern identifier, depending on which pattern table an entry was selected from. The corresponding attributes in the selected entry is duplicated into the entry of the keyword list 40. For example, if an entry of the image pattern table 32 is selected to be merged into the keyword list 40, the generic pattern identifier, the generic pattern name, the generic pattern count, and the generic pattern weight respectively duplicates the image pattern identifier, the image pattern name, the image pattern count, and the image pattern weight of the selected entry of the image pattern table 32. If an entry of the word pattern table 33 is selected to be merged into the keyword list 40, the generic pattern identifier, the generic pattern name, the generic pattern count, and the generic pattern weight respectively duplicates the word pattern identifier, the word pattern name, the word pattern count, and the word pattern weight of the selected entry of the word pattern table 33. An administrator of the web server 11 determines how many entries will be kept in the keyword list 40. The keyword automating process 20 automates manual keyword creation and assignment of conventional video content handling methods.

The search engine 14 accesses the keyword list 40 to service a search request for the video content 31. The search request is received from an end user who wants to search the video content 31 with a keyword listed as generic pattern name in the keyword list 40.

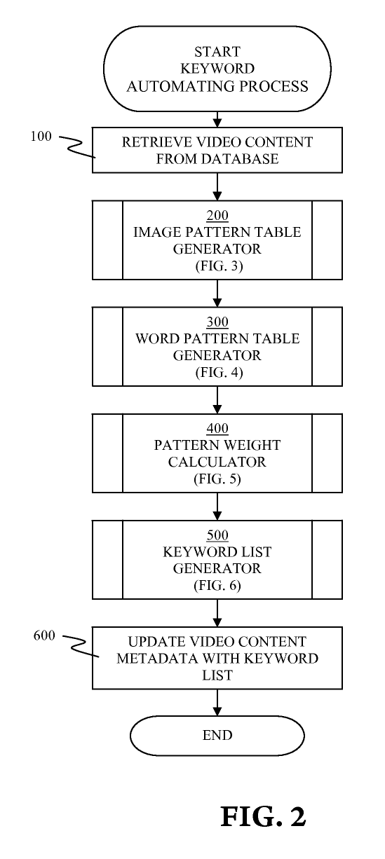

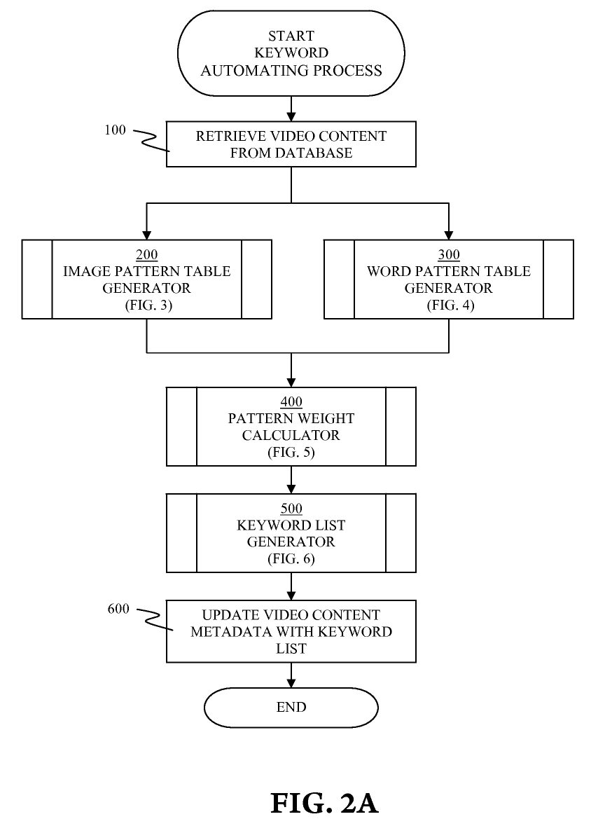

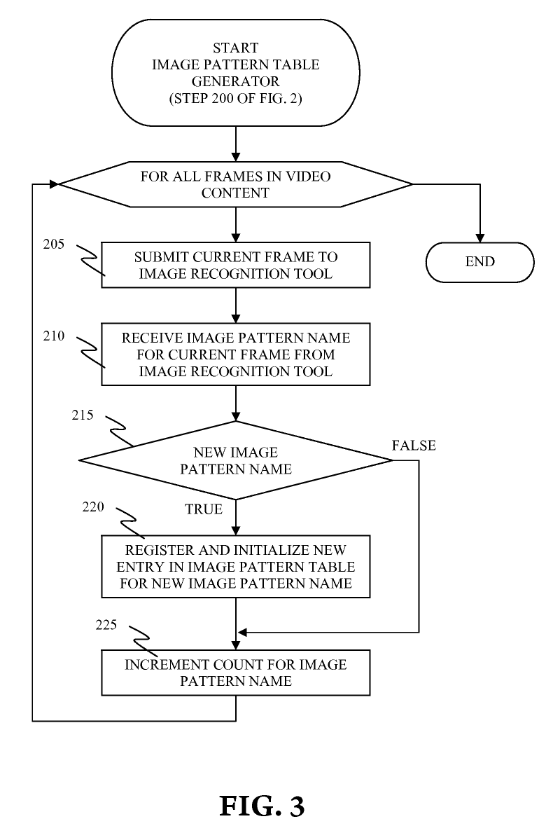

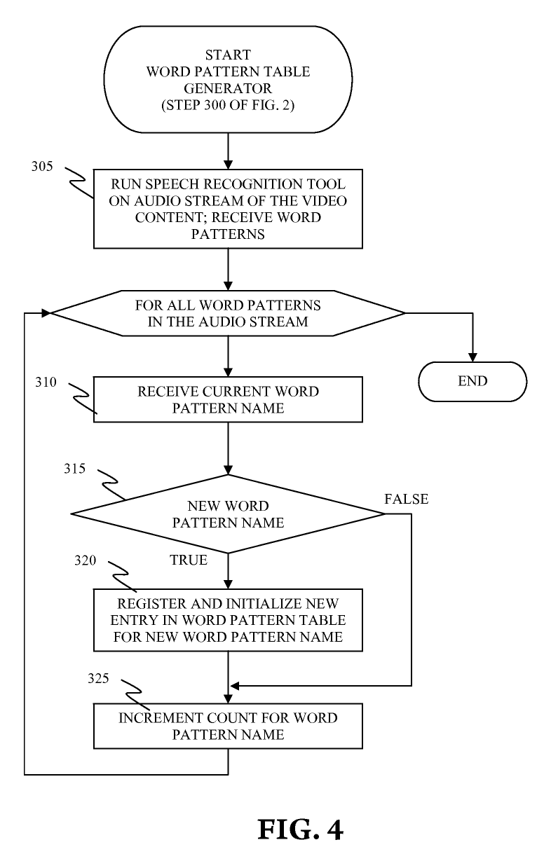

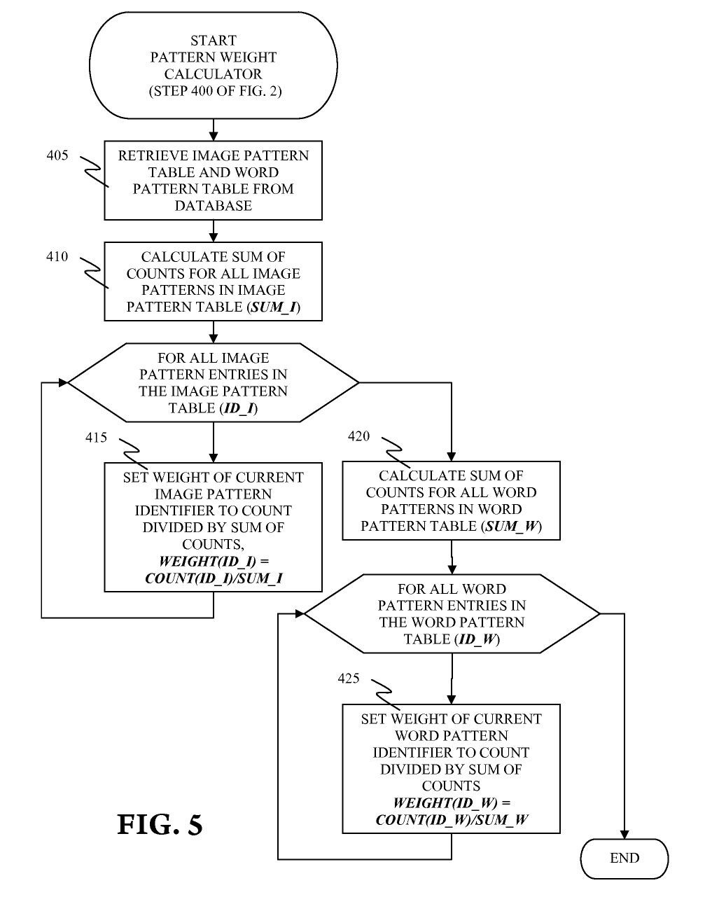

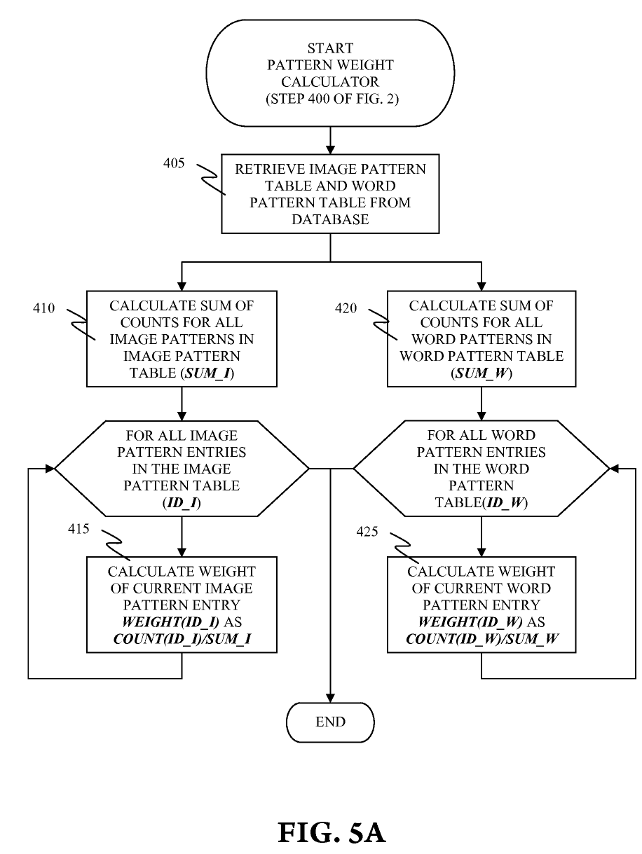

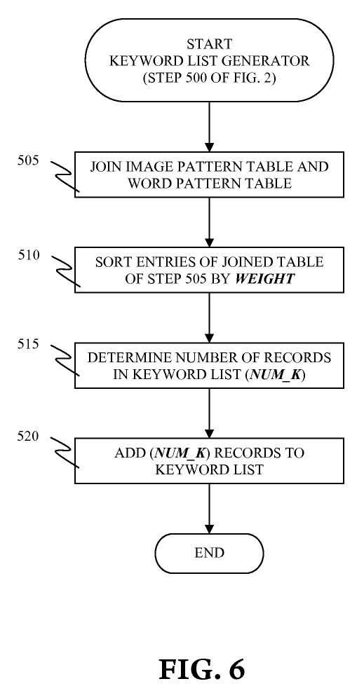

FIG. 2 and FIG. 2A are flowcharts depicting a method for automatically generating and associating search keywords for video content, in accordance with the embodiments of the present invention.

In step 100, the keyword automating process retrieves the video content from the database. Then the keyword automating process proceeds with step 200.

In step 200, the keyword automating process generates an image pattern table for image frames of the retrieved video content by performing an image pattern table generator. See descriptions of FIG. 3 infra for steps performed by the image pattern table generator. The image pattern table generator is a sub-concept but not necessarily a separate sub-module of the keyword automating process. Then the keyword automating process proceeds with step 300.

In step 300, the keyword automating process generates a word pattern table for an audio stream of the retrieved video content by performing a word pattern table generator. See descriptions of FIG. 4 infra for steps performed by the word pattern table generator. Then the keyword automating process proceeds with step 400.

As shown in FIG. 2A, step 200 and step 300 can be concurrently performed. Because the image pattern table generator and the word pattern table generator only share the video content as an input but do not have any sequential dependency with each other in creating the image pattern table and the word pattern table, concurrently performing step 200 and step 300 result in the same set of the image pattern table and the word pattern table as sequentially performing step 200 and step 300.

In step 400, the keyword automating process calculates a relative weight of each image pattern and word pattern by performing a pattern weight calculator. The relative weight of each image pattern and word pattern represents how frequently a specific pattern appears relative to a total number of image patterns or word patterns. See descriptions of FIG. 5 infra for steps performed by the pattern weight calculator. Then the keyword automating process proceeds with step 500.

In step 500, the keyword automating process generates a keyword list by performing a keyword list generator. See descriptions of FIG. 6 infra for steps performed by the keyword list generator. Then the keyword automating process proceeds with step 600.

In step 600, the keyword automating process updates metadata of a web page associated with the video content to integrate the generated keyword list such that the keyword list is utilized in servicing web search requests to the web server for the video contents that employs the metadata. Then the keyword automating process terminates.

FIG. 3 is a flowchart depicting a method for generating the image pattern table for the video content of FIG. 2 supra, being performed by the image pattern table generator, in accordance with the embodiments of the present invention.

The image pattern table generator iterates step 205 through step 225 for each image frame in the video content that the keyword automating process has received in step 100 of FIG. 2, supra. When the image pattern table generator completes processing all image frames in the video content, the image pattern table generator terminates and the keyword automating process resumes operation.

In step 205, the image pattern table generator submits a current image frame to the image recognition tool. In response to step 205, the image recognition tool generates a current image pattern name corresponding to the current image frame and sends the current image pattern name to the image pattern table generator. Then the image pattern table generator proceeds with step 210.

In step 210, the image pattern table generator receives the current image pattern name for the current image frame from the image recognition tool. Then the image pattern table generator proceeds with step 215.

In step 215, the image pattern table generator determines whether the current image pattern name is new. If the image pattern table generator determines that the current image pattern name is new, then the image pattern table generator proceeds with step 220. If the image pattern table generator determines that the current image pattern name already exists in the image pattern table, then the image pattern table generator proceeds with step 225.

In step 220, the image pattern table generator registers a new entry for the current image pattern name in the image pattern table and initializes all attributes of the new entry. The image pattern table generator assigns a unique integer value to image pattern identifier ID_I of the new entry. The image pattern table generator assigns the new image pattern name to image pattern name of the new entry. The image pattern table generator initializes image pattern count of the new entry COUNT(ID_I) and image pattern weight of the new entry WEIGHT(ID_I) as zero (0), respectively. Then the image pattern table generator proceeds with step 225.

In step 225, the image pattern table generator increases image pattern count of an entry in the image pattern table corresponding to the current image frame, either an existing entry as determined in step 215 or the new entry registered in step 220. Then the image pattern table loops back to step 205 to process a next image frame from the video content.

FIG. 4 is a flowchart depicting a method for generating the word pattern table for the video content of FIG. 2 supra, being performed by the word pattern table generator, in accordance with the embodiments of the present invention.

In step 305, the word pattern table generator receives word patterns as a result of performing the speech recognition tool on an audio stream of the video content. The word pattern table generator proceeds with step 310.

The word pattern table generator iterates step 310 through step 325 for each word pattern in the audio stream of the video content that the keyword automating process has received in step 100 of FIG. 2, supra. When the word pattern table generator completes processing all word patterns in the audio stream of the video content, the word pattern table generator terminates and the keyword automating process resumes operation.

In step 310, the word pattern table generator receives a current word pattern name generated by the speech recognition tool. Then the word pattern table generator proceeds with step 315.

In step 315, the word pattern table generator determines whether the current word pattern name is new. If the word pattern table generator determines that the current word pattern name is new, then the word pattern table generator proceeds with step 320. If the word pattern table generator determines that the current word pattern name already exists in the word pattern table, then the word pattern table generator proceeds with step 325.

In step 320, the word pattern table generator registers a new entry for the current word pattern name in the word pattern table and initializes all attributes of the new entry. The word pattern table generator assigns a unique integer value to word pattern identifier ID_W of the new entry. The word pattern table generator assigns the new word pattern name to word pattern name of the new entry. The word pattern table generator initializes word pattern count of the new entry COUNT(ID_W) and word pattern weight of the new entry WEIGHT(ID_W) as zero (0), respectively. Then the word pattern table generator proceeds with step 325.

In step 325, the word pattern table generator increases word pattern count of an entry in the word pattern table corresponding to the current word pattern name, either an existing entry as determined in step 315 or the new entry registered in step 320. Then the word pattern table loops back to step 310 to process a next word pattern name the audio stream of the video content.

FIG. 5 and FIG. 5A are flowcharts depicting a method for calculating relative weights of image pattern names of the image pattern table and relative weights of word pattern names of the word pattern table, being performed by the pattern weight calculator, in accordance with the embodiments of the present invention.

In step 405, the pattern weight calculator retrieves the image pattern table and the word pattern table from the database. Then the pattern weight calculator proceeds with step 410.

In step 410, the pattern weight calculator calculates and stores a sum of image pattern counts SUM_I for all image patterns in the image pattern table. Then the pattern weight calculator proceeds with step 415.

The pattern weight calculator performs step 415 for all image pattern entries that are uniquely identified by each image pattern identifier ID_I of the image pattern table.

In step 415, the pattern weight calculator calculates a weight of a current image pattern entry as image pattern count of the current image pattern entry divided by the sum of image pattern counts SUM_I from step 410, that is, WEIGHT(ID_I)=COUNT(ID_I)/SUM_I. The pattern weight calculator proceeds with step 420 upon completing step 415 for all image pattern entries in the image pattern table.

In step 420, the pattern weight calculator calculates and stores a sum of word pattern counts SUM_W for all word pattern entries in the word pattern table. Then the pattern weight calculator proceeds with step 425.

The pattern weight calculator performs step 425 for all word pattern entries that are uniquely identified by the word pattern identifier ID_W of the word pattern table.

In step 425, the pattern weight calculator calculates word pattern weight of a current word pattern entry as word pattern count of the current word pattern entry divided by the sum of word pattern counts SUM_W from step 420, that is, WEIGHT(ID_W)=COUNT(ID_W)/SUM_W. The pattern weight calculator terminates upon completing step 425 for all word pattern entries in the word pattern table. The keyword automating process of FIGS. 2 and 2A, supra, proceeds with the keyword list generator in step 500.

In an embodiment depicted in FIG. 5A, the pattern weight calculator concurrently performs a first branch comprising steps 410 and 415 and a second branch comprising steps 420 and 425, because the image pattern table and the word pattern table are independent from each other.

FIG. 6 is a flowchart depicting a method for generating the keyword list for the video content of FIG. 2 supra, being performed by the keyword list generator, in accordance with the embodiments of the present invention.

In step 505, the keyword list generator joins the image pattern table and the word pattern table. As a result, the keyword list generator creates a joined table comprising all entries from the image pattern table and the word pattern table. Each entry of the joined table has four attributes of generic pattern identifier, generic pattern name, generic pattern count and generic pattern weight. The generic pattern identifier of each entry ID is assigned from either image pattern identifier of the image pattern table ID_I or word pattern identifier of the word pattern table ID_W. The generic pattern name of each entry NAME is assigned from either image pattern name of the image pattern table or word pattern name of the word pattern table, that is, either NAME(ID_I) or NAME(ID_W). The generic pattern count of each entry COUNT is assigned from either image pattern count of the image pattern table or word pattern count of the word pattern table, that is, either COUNT(ID_I) or COUNT(ID_W). The generic pattern weight of each entry WEIGHT is assigned from either image pattern weight of the image pattern table or word pattern weight of the word pattern table, that is, either WEIGHT(ID_I) or WEIGHT (ID_W). Then the keyword list generator proceeds with step 510.

In step 510, the keyword list generator sorts entries of the joined table from step 505 by values of generic pattern weight WEIGHT of the entries. Then the keyword list generator proceeds with step 515.

In step 515, the keyword list generator determines a number of records in the keyword list NUM_K from a user input or a predefined value based on the range of weight value, etc. Then the keyword list generator proceeds with step 520.

In step 520, the keyword list generator selects NUM_K entries that have the largest weight values from the joined table of step 505 and adds the NUM_K selected entries to the keyword list. Then the keyword list generator terminates and the keyword automating process continues with step 600 of FIGS. 2 and 2A, supra.

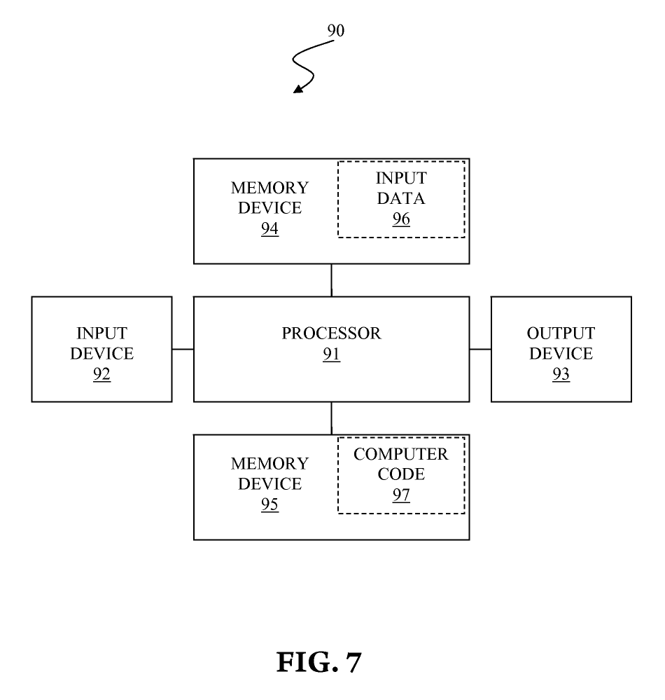

FIG. 7 illustrates a computer system used for automating keywords for video content, in accordance with the embodiments of the present invention.

The computer system 90 comprises a processor 91, an input device 92 coupled to the processor 91, an output device 93 coupled to the processor 91, and computer readable memory units comprising memory devices 94 and 95 each coupled to the processor 91. The input device 92 may be, inter alia, a keyboard, a mouse, a keypad, a touch screen, a voice recognition device, a sensor, a network interface card (NIC), a Voice/video over Internet Protocol (VOIP) adapter, a wireless adapter, a telephone adapter, a dedicated circuit adapter, etc. The output device 93 may be, inter alia, a printer, a plotter, a computer screen, a magnetic tape, a removable hard disk, a floppy disk, a NIC, a VOIP adapter, a wireless adapter, a telephone adapter, a dedicated circuit adapter, an audio and/or visual signal generator, a light emitting diode (LED), etc. The memory devices 94 and 95 may be, inter alia, a cache, a dynamic random access memory (DRAM), a read-only memory (ROM), a hard disk, a floppy disk, a magnetic tape, an optical storage such as a compact disk (CD) or a digital video disk (DVD), etc. The memory device 95 includes a computer code 97 which is a computer program code that comprises computer-executable instructions. The computer code 97 includes, inter alia, an algorithm used for automating keywords for the video content according to the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 7) may be used as a computer readable storage medium (or a computer usable storage medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer readable storage medium (or said program storage device).

Any of the components of the present invention can be deployed, managed, serviced, etc. by a service provider that offers to deploy or integrate computing infrastructure with respect to a process for dynamically building a web interface per data collecting rules of the present invention. Thus, the present invention discloses a process for supporting computer infrastructure, comprising integrating, hosting, maintaining and deploying computer-readable code into a computing system (e.g., computing system 90), wherein the code in combination with the computing system is capable of performing a method for automating keywords for the video content.

In another embodiment, the invention provides a business method that performs the process steps of the invention on a subscription, advertising and/or fee basis. That is, a service provider, such as a Solution Integrator, can offer to create, maintain, support, etc. a process for automating keywords for the video content of the present invention. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

While FIG. 7 shows the computer system 90 as a particular configuration of hardware and software, any configuration of hardware and software, as would be known to a person of ordinary skill in the art, may be utilized for the purposes stated supra in conjunction with the particular computer system 90 of FIG. 7. For example, the memory devices 94 and 95 may be portions of a single memory device rather than separate memory devices.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) 94, 95 may be utilized. The term computer usable medium or computer readable medium collectively refers to computer usable/readable storage medium 94, 95. The computer-usable or computer-readable medium 94, 95 may be, for example but not limited to, an electronic, magnetic, optical, electromagnetic, infrared, or semiconductor system, apparatus, a device, or any suitable combination of the foregoing. More specific examples (a non-exhaustive list) of the computer-readable medium 94, 95 would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Note that the computer-usable or computer-readable medium 94, 95 could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium 94, 95 may be any medium that can contain, or store a program for use by or in connection with a system, apparatus, or device that executes instructions.

Computer code 97 for carrying out operations of the present invention may be written in any combination of one or more programming languages, including an object oriented programming language such as Java, Smalltalk, C++ or the like and conventional procedural programming languages, such as the “C” programming language or similar programming languages. The computer code 97 may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. The term “computer program instructions” is interchangeable with the term “computer code 97” in this specification. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in the computer-readable medium 94, 95 that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for automatically processing keyword for video content, said method comprising:
a processor of a computer system loading said video content, said video content comprising at least one image frame and an audio stream;
said processor generating an image pattern table from said at least one image frame, wherein an entry of the image pattern table comprises attributes of image pattern identifier ID_I, image pattern name, image pattern count COUNT(ID_I), and image pattern weight WEIGHT(ID_I), wherein the image pattern identifier ID_I identifies an image pattern in said at least one image frame, wherein the image pattern name is an alphanumeric text representing the image pattern, wherein the image pattern count COUNT(ID_I) represents a number of appearances of the image pattern in said at least one image frame, and wherein the image pattern weight WEIGHT(ID_I) represents a relative frequency of the image pattern within said at least one image frame;
said processor generating a word pattern table from the audio stream, wherein an entry of the word pattern table comprises attributes of word pattern identifier ID_W, word pattern name, word pattern count COUNT(ID_W), and word pattern weight WEIGHT(ID_W), wherein the word pattern identifier ID_W identifies a word pattern in the audio stream, wherein the word pattern name is an alphanumeric text representing the word pattern, wherein the word pattern count COUNT(ID_W) represents a number of appearances of the word pattern in the audio stream, and wherein the word pattern weight WEIGHT(ID_W) represents a relative frequency of the word pattern within the audio stream;
said processor calculating the respective weight for all entries in the image pattern table and the word pattern table, wherein the respective weight is selected from the group consisting of the image pattern weight WEIGHT(ID_I) and the word pattern weight WEIGHT(ID_W);
said processor generating a keyword list from the image pattern table and the word pattern table based on the calculated weight, wherein an entry of the keyword list is selected from the group consisting of entries of the image pattern table and entries of the word pattern table, and wherein the entry of the keyword list comprises attributes of generic pattern identifier, generic pattern name, generic pattern count, and generic pattern weight; and
said processor integrating the generated keyword list into metadata of a web page associated with the video content such that the keyword list is utilized in web searches employing the metadata.

2. The method of claim 1, said generating the image pattern table comprising:
generating the image pattern identifier ID_I that uniquely identifies each image frame of the video content; and
assigning the image pattern name that has been provided by an image recognition tool as a result of analyzing each image frame of said at least one image frame of the video content, wherein said image recognition tool logically groups similar image patterns with an identical image pattern name.

3. The method of claim 1, said generating the word pattern table comprising:
generating the word pattern identifier ID_W that uniquely identifies each word pattern in the audio stream of the video content; and
assigning the word pattern name that has been provided by a speech recognition tool as a result of analyzing each word pattern of said audio stream, wherein said speech recognition tool logically groups similar word patterns with an identical word pattern name.

4. The method of claim 1, said calculating the respective weight comprising:
calculating the image pattern weight WEIGHT(ID_I) for each entry in the image pattern table via WEIGHT(ID_I)=COUNT(ID_I)/SUM_I, wherein SUM_I is the sum of all image pattern counts in the image pattern table; and
calculating the word pattern weight WEIGHT(ID_W) for each entry in the word pattern table via WEIGHT(ID_W)=COUNT(ID_W)/SUM_W, wherein SUM_W is the sum of all word pattern counts in the word pattern table.

5. The method of claim 4, said generating the keyword list comprising:
joining the image pattern table and the word pattern table into the keyword list by mapping, for each entry of the image pattern table, the image pattern identifier, the image pattern name, the image pattern count, and the image pattern weight attributes of said each entry of the image pattern table to the generic pattern identifier, the generic pattern name, the generic pattern count, and the generic pattern weight attributes of a corresponding entry of the keyword list, respectively, and by mapping, for each entry of the word pattern table, the word pattern identifier, the word pattern name, the word pattern count, and the word pattern weight attributes of said each entry of the word pattern table to the generic pattern identifier, the generic pattern name, the generic pattern count, and the generic pattern weight attributes of another corresponding entry of the keyword list, respectively;
selecting K number of entries of the keyword list that have largest values of the generic pattern weight, wherein K is a positive integer; and
storing generic pattern names of selected K number of entries as the keyword list to a computer readable storage medium coupled to said processor.

6. A computer program product comprising:
a computer readable storage medium having a computer readable program code embodied therein, said computer readable program code containing instructions that perform a method for automatically processing keyword for video content, said method comprising:
loading said video content, said video content comprising at least one image frame and an audio stream;
generating an image pattern table from said at least one image frame, wherein an entry of the image pattern table comprises attributes of image pattern identifier ID_I, image pattern name, image pattern count COUNT(ID_I), and image pattern weight WEIGHT(ID_I), wherein the image pattern identifier ID_I identifies an image pattern in said at least one image frame, wherein the image pattern name is an alphanumeric text representing the image pattern, wherein the image pattern count COUNT(ID_I) represents a number of appearances of the image pattern in said at least one image frame, and wherein the image pattern weight WEIGHT(ID_I) represents a relative frequency of the image pattern within said at least one image frame;
generating a word pattern table from the audio stream, wherein an entry of the word pattern table comprises attributes of word pattern identifier ID_W, word pattern name, word pattern count COUNT(ID_W), and word pattern weight WEIGHT(ID_W), wherein the word pattern identifier ID_W identifies a word pattern in the audio stream, wherein the word pattern name is an alphanumeric text representing the word pattern, wherein the word pattern count COUNT(ID_W) represents a number of appearances of the word pattern in the audio stream, and wherein the word pattern weight WEIGHT(ID_W) represents a relative frequency of the word pattern within the audio stream;
calculating the respective weight for all entries in the image pattern table and the word pattern table, wherein the respective weight is selected from the group consisting of the image pattern weight WEIGHT(ID_I) and the word pattern weight WEIGHT(ID_W);
generating a keyword list from the image pattern table and the word pattern table based on the calculated weight, wherein an entry of the keyword list is selected from the group consisting of entries of the image pattern table and entries of the word pattern table, and wherein the entry of the keyword list comprises attributes of generic pattern identifier, generic pattern name, generic pattern count, and generic pattern weight; and
integrating the generated keyword list into metadata of a web page associated with the video content such that the keyword list is utilized in web searches employing the metadata.

7. The computer program product of claim 6, said generating the image pattern table comprising:
generating the image pattern identifier ID_I that uniquely identifies each image frame of the video content; and
assigning the image pattern name that has been provided by an image recognition tool as a result of analyzing each image frame of said at least one image frame of the video content, wherein said image recognition tool logically groups similar image patterns with an identical image pattern name.

8. The computer program product of claim 6, said generating the word pattern table comprising:
generating the word pattern identifier ID_W that uniquely identifies each word pattern in the audio stream of the video content; and
assigning the word pattern name that has been provided by a speech recognition tool as a result of analyzing each word pattern of said audio stream, wherein said speech recognition tool logically groups similar word patterns with an identical word pattern name.

9. The computer program product of claim 6, said calculating the respective weight comprising:
calculating the image pattern weight WEIGHT(ID_I) for each entry in the image pattern table via WEIGHT(ID_I)=COUNT(ID_I)/SUM_I, wherein SUM_I is the sum of all image pattern counts in the image pattern table; and
calculating the word pattern weight WEIGHT(ID_W) for each entry in the word pattern table via WEIGHT(ID_W)=COUNT(ID_W)/SUM_W, wherein SUM_W is the sum of all word pattern counts in the word pattern table.

10. The computer program product of claim 9, said generating the keyword list comprising:
merging entries of the image pattern table and the word pattern table;
sorting the merged entries in a descending order of the generic pattern weight, wherein the generic pattern weight is equal to the image pattern weight WEIGHT(ID_I) if the merged entry is an entry of the image pattern table, and wherein the generic pattern weight is equal to the word pattern weight WEIGHT(ID_W) if the merged entry is an entry of the word pattern table;
selecting K number of entries from the top of the merged entries such that the selected K entries have K largest values of the generic pattern weight, wherein K is a positive integer, wherein the generic pattern identifier, the generic pattern name, and the generic pattern count is respectively mapped from the image pattern identifier, the image pattern name, and the image pattern count if the selected entry is an entry of the image pattern table, and wherein the generic pattern identifier, the generic pattern name, and the generic pattern count is respectively mapped from the word pattern identifier, the word pattern name, and the word pattern count if the selected entry is an entry of the word pattern table; and
adding generic pattern names of the selected K entries to the keyword list, wherein the keyword list is stored in the computer readable storage medium.

11. A computer system comprising a processor and a computer readable memory unit coupled to the processor, said computer readable memory unit containing instructions that when run by the processor implement a method for automatically processing keyword for video content, said method comprising:
loading said video content, said video content comprising at least one image frame and an audio stream;
generating an image pattern table from said at least one image frame, wherein an entry of the image pattern table comprises attributes of image pattern identifier ID_I, image pattern name, image pattern count COUNT(ID_I), and image pattern weight WEIGHT(ID_I), wherein the image pattern identifier ID_I identifies an image pattern in said at least one image frame, wherein the image pattern name is an alphanumeric text representing the image pattern, wherein the image pattern count COUNT(ID_I) represents a number of appearances of the image pattern in said at least one image frame, and wherein the image pattern weight WEIGHT(ID_I) represents a relative frequency of the image pattern within said at least one image frame;
generating a word pattern table from the audio stream, wherein an entry of the word pattern table comprises attributes of word pattern identifier ID_W, word pattern name, word pattern count COUNT(ID_W), and word pattern weight WEIGHT(ID_W), wherein the word pattern identifier ID_W identifies a word pattern in the audio stream, wherein the word pattern name is an alphanumeric text representing the word pattern, wherein the word pattern count COUNT(ID_W) represents a number of appearances of the word pattern in the audio stream, and wherein the word pattern weight WEIGHT(ID_W) represents a relative frequency of the word pattern within the audio stream;
calculating the respective weight for all entries in the image pattern table and the word pattern table, wherein the respective weight is selected from the group consisting of the image pattern weight WEIGHT(ID_I) and the word pattern weight WEIGHT(ID_W);
generating a keyword list from the image pattern table and the word pattern table based on the calculated weight, wherein an entry of the keyword list is selected from the group consisting of entries of the image pattern table and entries of the word pattern table, and wherein the entry of the keyword list comprises attributes of generic pattern identifier, generic pattern name, generic pattern count, and generic pattern weight; and
integrating the generated keyword list into metadata of a web page associated with the video content such that the keyword list is utilized in web searches employing the metadata.

12. The computer system of claim 11, said generating the image pattern table comprising:
generating the image pattern identifier ID_I that uniquely identifies each image frame of the video content; and
assigning the image pattern name that has been provided by an image recognition tool as a result of analyzing each image frame of said at least one image frame of the video content, wherein said image recognition tool logically groups similar image patterns with an identical image pattern name.

13. The computer system of claim 11, said generating the word pattern table comprising:
generating the word pattern identifier ID_W that uniquely identifies each word pattern in the audio stream of the video content; and
assigning the word pattern name that has been provided by a speech recognition tool as a result of analyzing each word pattern of said audio stream, wherein said speech recognition tool logically groups similar word patterns with an identical word pattern name.

14. The computer system of claim 11, said calculating the respective weight comprising:
calculating the image pattern weight WEIGHT(ID_I) for each entry in the image pattern table via WEIGHT(ID_I)=COUNT(ID_I)/SUM_I, wherein SUM_I is the sum of all image pattern counts in the image pattern table; and
calculating the word pattern weight WEIGHT(ID_W) for each entry in the word pattern table via WEIGHT(ID_W)=COUNT(ID_W)/SUM_W, wherein SUM_W is the sum of all word pattern counts in the word pattern table.

15. The computer system of claim 14, said generating the keyword list comprising:
joining the image pattern table and the word pattern table into the keyword list by mapping, for each entry of the image pattern table, the image pattern identifier, the image pattern name, the image pattern count, and the image pattern weight attributes of said each entry of the image pattern table to the generic pattern identifier, the generic pattern name, the generic pattern count, and the generic pattern weight attributes of a corresponding entry of the keyword list, respectively, and by mapping, for each entry of the word pattern table, the word pattern identifier, the word pattern name, the word pattern count, and the word pattern weight attributes of said each entry of the word pattern table to the generic pattern identifier, the generic pattern name, the generic pattern count, and the generic pattern weight attributes of another corresponding entry of the keyword list, respectively;
selecting K number of entries of the keyword list that have largest values of the generic pattern weight, wherein K is a positive integer; and
storing generic pattern names of selected K number of entries as the keyword list to a computer readable storage medium coupled to said processor.

16. A process for supporting computer infrastructure, said process comprising providing at least one support service for at least one of creating, integrating, hosting, maintaining, and deploying computer-readable code in a computing system, wherein the code in combination with the computing system is capable of performing a method for automatically processing keyword for video content, said method comprising:
loading said video content, said video content comprising at least one image frame and an audio stream;
generating an image pattern table from said at least one image frame, wherein an entry of the image pattern table comprises attributes of image pattern identifier ID_I, image pattern name, image pattern count COUNT(ID_I), and image pattern weight WEIGHT(ID_I), wherein the image pattern identifier ID_I identifies an image pattern in said at least one image frame, wherein the image pattern name is an alphanumeric text representing the image pattern, wherein the image pattern count COUNT(ID_I) represents a number of appearances of the image pattern in said at least one image frame, and wherein the image pattern weight WEIGHT(ID_I) represents a relative frequency of the image pattern within said at least one image frame;
generating a word pattern table from the audio stream, wherein an entry of the word pattern table comprises attributes of word pattern identifier ID_W, word pattern name, word pattern count COUNT(ID_W), and word pattern weight WEIGHT(ID_W), wherein the word pattern identifier ID_W identifies a word pattern in the audio stream, wherein the word pattern name is an alphanumeric text representing the word pattern, wherein the word pattern count COUNT(ID_W) represents a number of appearances of the word pattern in the audio stream, and wherein the word pattern weight WEIGHT(ID_W) represents a relative frequency of the word pattern within the audio stream;
calculating the respective weight for all entries in the image pattern table and the word pattern table, wherein the respective weight is selected from the group consisting of the image pattern weight WEIGHT(ID_I) and the word pattern weight WEIGHT(ID_W);
generating a keyword list from the image pattern table and the word pattern table based on the calculated weight, wherein an entry of the keyword list is selected from the group consisting of entries of the image pattern table and entries of the word pattern table, and wherein the entry of the keyword list comprises attributes of generic pattern identifier, generic pattern name, generic pattern count, and generic pattern weight; and
integrating the generated keyword list into metadata of a web page associated with the video content such that the keyword list is utilized in web searches employing the metadata.

17. The process of claim 16, said generating the image pattern table comprising:
generating the image pattern identifier ID_I that uniquely identifies each image frame of the video content; and
assigning the image pattern name that has been provided by an image recognition tool as a result of analyzing each image frame of said at least one image frame of the video content, wherein said image recognition tool logically groups similar image patterns with an identical image pattern name.

18. The process of claim 16, said generating the word pattern table comprising:
generating the word pattern identifier ID_W that uniquely identifies each word pattern in the audio stream of the video content; and
assigning the word pattern name that has been provided by a speech recognition tool as a result of analyzing each word pattern of said audio stream, wherein said speech recognition tool logically groups similar word patterns with an identical word pattern name.

19. The process of claim 16, said calculating the respective weight comprising:
calculating the image pattern weight WEIGHT(ID_I) for each entry in the image pattern table via WEIGHT(ID_I)=COUNT(ID_I)/SUM_I, wherein SUM_I is the sum of all image pattern counts in the image pattern table; and
calculating the word pattern weight WEIGHT(ID_W) for each entry in the word pattern table via WEIGHT(ID_W)=COUNT(ID_W)/SUM_W, wherein SUM_W is the sum of all word pattern counts in the word pattern table.

20. The process of claim 19, said generating the keyword list comprising:
merging entries of the image pattern table and the word pattern table;
sorting the merged entries in a descending order of the generic pattern weight, wherein the generic pattern weight is equal to the image pattern weight WEIGHT(ID_I) if the merged entry is an entry of the image pattern table, and wherein the generic pattern weight is equal to the word pattern weight WEIGHT(ID_W) if the merged entry is an entry of the word pattern table;
selecting K number of entries from the top of the merged entries such that the selected K entries have K largest values of the generic pattern weight, wherein K is a positive integer, wherein the generic pattern identifier, the generic pattern name, and the generic pattern count is respectively mapped from the image pattern identifier, the image pattern name, and the image pattern count if the selected entry is an entry of the image pattern table, and wherein the generic pattern identifier, the generic pattern name, and the generic pattern count is respectively mapped from the word pattern identifier, the word pattern name, and the word pattern count if the selected entry is an entry of the word pattern table; and
adding generic pattern names of the selected K entries to the keyword list, wherein the keyword list is stored in a computer readable storage medium coupled to the computer system.
